(19) United States
(12) Patent Application Publication
(10) Pub. No.: US 2026/0342221 A1
(43) Pub. Date: Oct. 29, 2026

(54) METHOD FOR PRECHARGING A DC LINK CAPACITOR IN A BIDIRECTIONAL DC POWER SUPPLY WITH THREE-PHASE INPUT

(71) Applicant: EA Elektro-Automatik GmbH, Viersen (DE)

(72) Inventors: Arne Pagel, Schwalmtal (DE); Kevin Felsing, Geldern (DE); Stefan Wohlers, Grefrath (DE)

(21) Appl. No.: 19/650,071

(22) Filed: Apr. 16, 2026

Related U.S. Application Data
(60) Provisional application No. 63/794,972, filed on Apr. 25, 2025.

(51) Int. Cl. H02M 1/42; H02J 7/04; H02J 7/34; H02J 7/80; H02J 7/90; H02M 7/06

(52) U.S. Cl. CPC H02M 1/4233; H02J 7/04; H02J 7/345; H02J 7/80; H02J 7/933; H02M 1/4258; H02M 7/066; H02J 2207/20; H02J 2207/50

(57) ABSTRACT

A power factor conversion (PFC) input stage to pre-charge a DC link has a three-phase power input, a rectifier in a main electrical path between the three-phase power input and the DC link, a controllable semiconductor device configured as a constant current source between the rectifier and the DC link, a controller, and a relay.

### CROSS-REFERENCE TO RELATED APPLICATIONS

This disclosure is a non-provisional of and claims benefit from U.S. Provisional Application No. 63/794,972, titled “METHOD FOR PRECHARGING A DC LINK CAPACITOR IN A BIDIRECTIONAL DC POWER SUPPLY WITH THREE-PHASE INPUT,” filed on Apr. 25, 2025, the disclosure of which is incorporated herein by reference in its entirety.

### TECHNICAL FIELD

This disclosure relates to power supplies, and more particularly to pre-charging a direct current (DC) link capacitor in a bidirectional dc power supply with three-phase input.

### BACKGROUND

A direct current (DC) laboratory power supply typically consists of a line filter, a bidirectional power factor correction (PFC) input stage and a galvanically isolated DC transmission path, as well as an optional application-specific output stage. FIG. 1 is a diagram illustrating a power supply circuit having three-phase power inputs 10, with a line filter 12, a bidirectional PFC input stage 14, and a galvanically isolated DC transmission path 18. Some instances have a further application-specific adjustment phase 20.

The PFC stage 14 in this type of device comprises a controlled three-phase full-wave bridge rectifier circuit (B6C) stage or variations thereof, such as neutral point clamped (NPC) inverters or T-Type inverters. The term “B6” refers to a three-phase bridge rectifier, which may also be a B6C bridge, where the C means “controlled.” In the discussion here, the term “B6C” will be used to encompass both of these types. In some examples, other inverter topologies are used that are suitable for PFC applications. One component of the PFC stage is a capacitor 16, also referred to as a DC link. Without appropriate pre-charging, switching on the device with an uncharged DC link would generate a very high current flow from the power grid, which could potentially trip upstream circuit breakers or damage the device itself.

FIG. 2 shows an example of a pre-charging method involves an arrangement of resistors, such as linear resistors, negative temperature coefficient thermistors (NTCs), or positive temperature coefficient thermistors (PTCs) like PTC 24, that are bypassed by a relay 26. The arrangement can be located on the alternating current (AC) side or on the DC side after auxiliary rectification or the B6C bridge 14. The disadvantage of the methods and architectures shown in FIG. 1 and FIG. 2 is that the resistors used must be designed for a correspondingly high peak power, resulting in a large construction volume, or alternatively, the pre-charging would take a very long time. One known solution exists in the form of a switching regulator but is primarily suitable for high-power converters. For low-power versions, the solution is costly and requires a relatively large installation space.

### BRIEF DESCRIPTION OF THE DRAWINGS

FIG. 1 shows an example of a bidirectional power factor correction (PFC) input stage.

FIG. 2 shows an example of a bidirectional PFC input stage using a relay bypass.

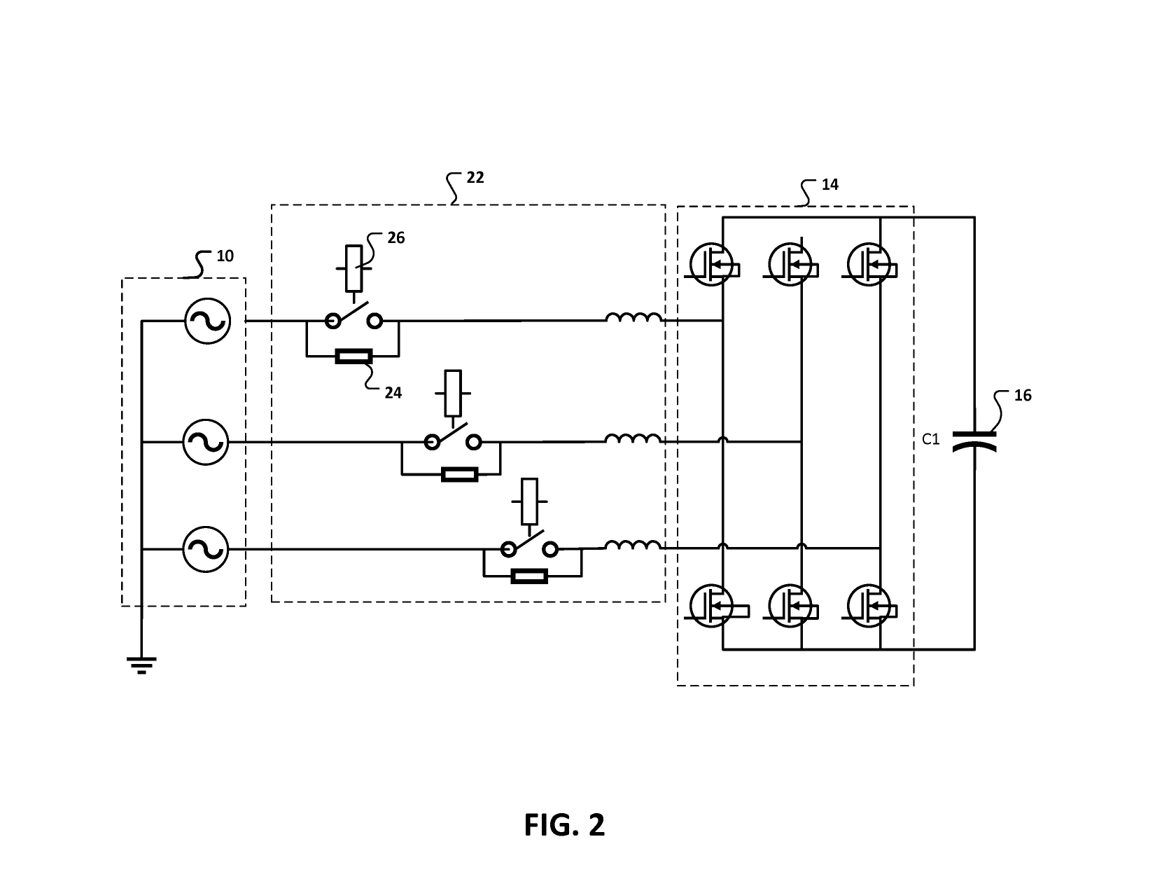

FIG. 3 shows an embodiment of a bidirectional PFC input stage using a controllable element.

FIG. 4 shows another embodiment of a bidirectional PFC input stage using a controllable element.

FIG. 5 shows a flowchart of an embodiment of a method of pre-charging a DC link capacitor.

### DETAILED DESCRIPTION

The embodiments disclosed herein involve a controllable device, such as a semiconductor switch or actuator in the DC part of the power factor correction (PFC) stage. The controllable semiconductor device may reside directly after the B6C stages or after a separate auxiliary rectification, both of which are described in more detail below. The controllable semiconductor device acts as a constant current source and is used in the pre-charging process. After a controller determines that the pre-charging has been completed, the controller uses a relay to bypass the controllable semiconductor device to avoid power loss during normal operations.

The present disclosure involves monitoring voltages in the PFC stages to determine completion of the pre-charging process. This may involve measuring the DC link voltage as well as the auxiliary voltage, meaning the voltage before the pre-charging device, for example, to detect the completion of the pre-charging process. The threshold for completion detection can be determined to be a high fraction of the AC Grid Peak Voltage.

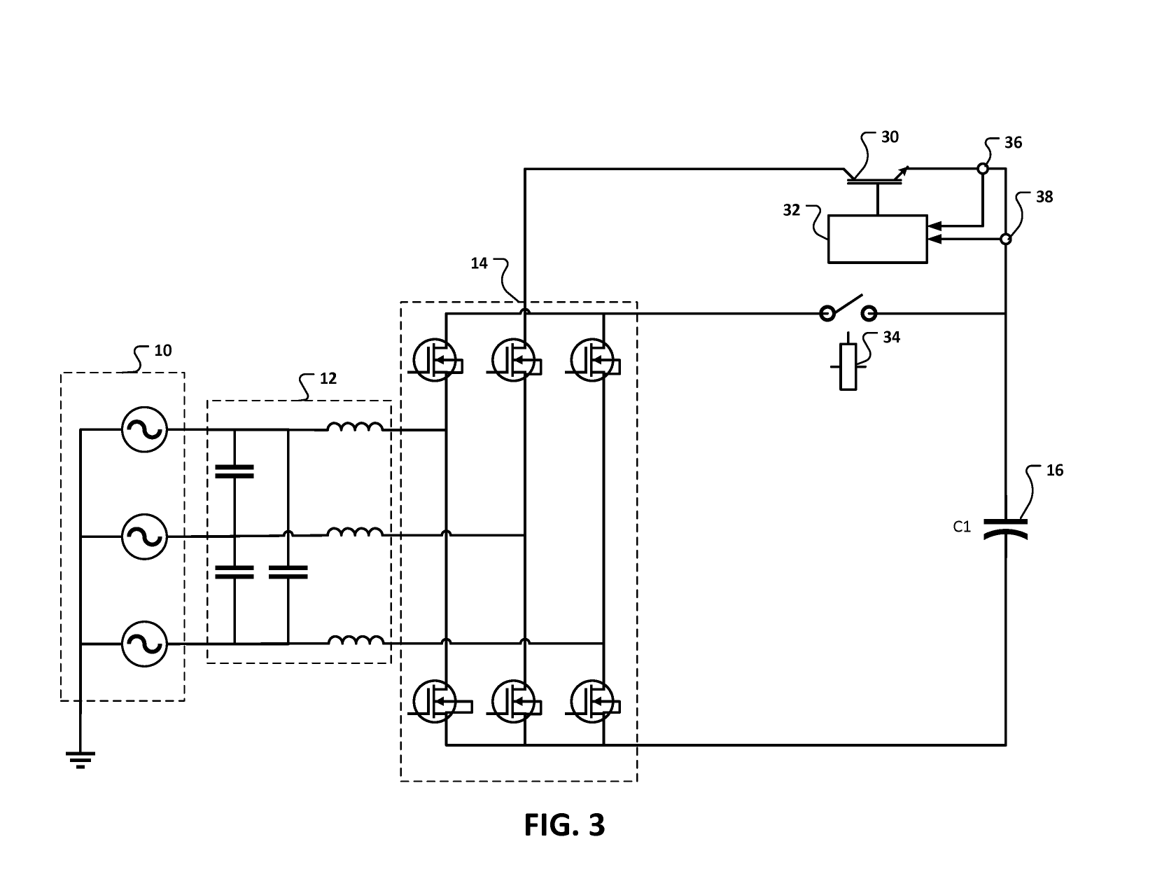

FIG. 3 shows an embodiment of a PFC stage that includes a controllable semiconductor device. The PFC stages receives a three-phase power input 10 and includes line filter 12. In this embodiment, the controllable semiconductor device comes directly after the B6C rectifier 14. The controller 32 may monitor the charging current at measurement point 36, and/or the DC link voltage at measurement point 38. The controller may comprise analog circuitry, a microcontroller, processor, field programmable gate array (FPGA), or other circuit or device that can receive inputs and perform actions depending upon the inputs the controller is receiving. For example, the controller may receive voltage measurements from those points and calculate the percentage of the AC Grid Peak Voltage, then compare that to the defined threshold and determine whether the process is complete. When the process is complete, the controller then triggers the relay 34 to cause the PFC stage to bypass the controllable semiconductor device.

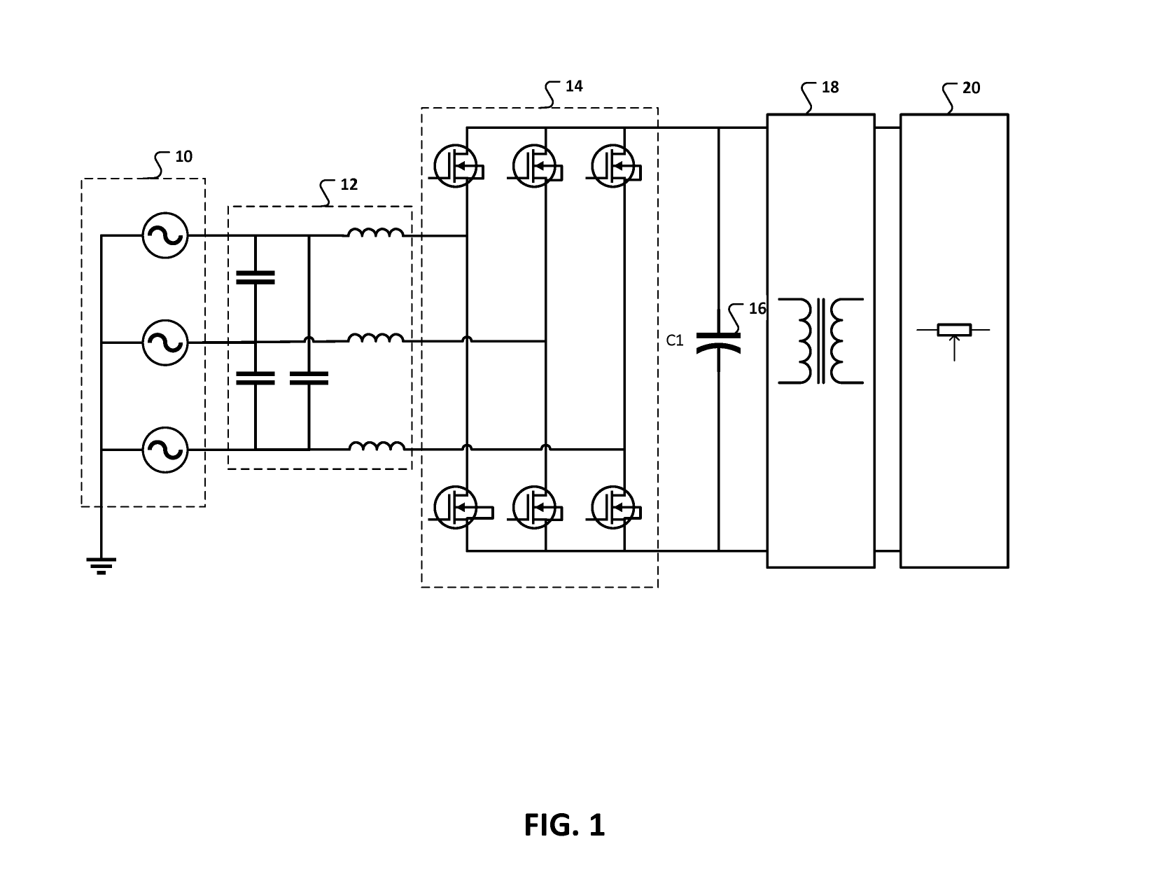

In the embodiment of FIG. 3, the B6C stage 14 acts as a rectifier during pre-charging. When the relay 34 closes, the circuit behaves as the circuit in FIG. 1. This configuration has a lower component count. The main B6C stages is always connected to the grid, which can cause a shorter lifetime. Relays in DC circuits are generally more expensive and may have some reliability issues.

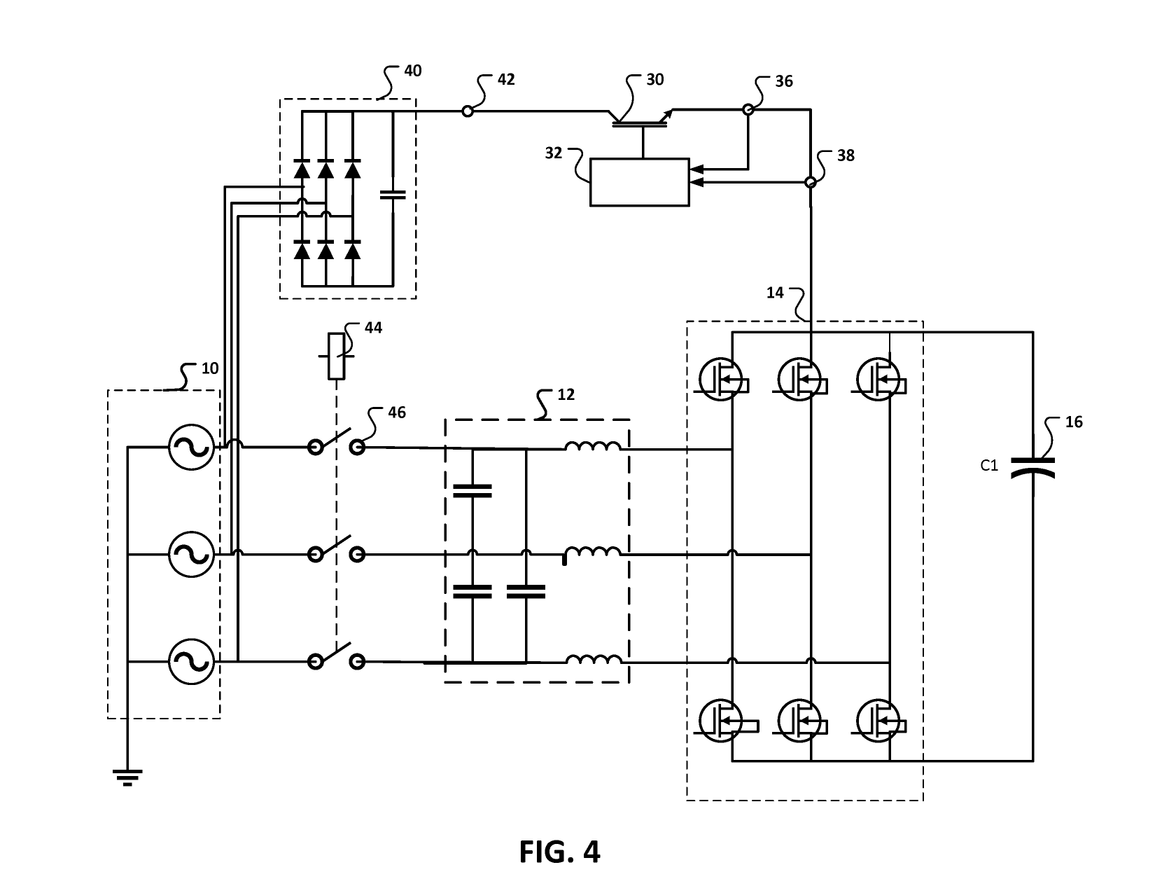

In the embodiment of FIG. 4, the pre-charging is done via auxiliary rectification. Diodes 40 act as the B6 rectifier during pre-charging. Once controller 32 has determined pre-charging has completed, the controller causes the relay 44 to close the paths to include the AC part of the PFC comprised of line filter 12 and rectifier 14. This method and architecture results in the main B6C rectifier 14 being disconnected from the grid during pre-charging. The relay only resides in the AC part of the path, alleviating some of the issues with DC relays. This architecture involves a higher component count but is a more cost-efficient solution. In addition, the system can measure the auxiliary voltage at 42 as an input to the controller.

In either embodiment, the determination of whether the pre-charging process has completed may involve the charging measurement 36, the DC link measurement at 38, and/or the auxiliary voltage measurement, or combinations thereof. In one embodiment, the DC link voltage measurement at 38 and the auxiliary voltage at 42 are used to determine completion of the pre-charging process.

In either embodiment, the rectifier lies in an electrical path between the three-phase power input and the DC link, either the main electrical path as in FIG. 3, or in the auxiliary rectification electrical path as in FIG. 4. Depending upon the architecture, activating the relay causes either the controllable semiconductor to be bypassed and therefore removed from the electrical path comprising the main electrical path, or activating the relay causes the entire auxiliary rectification path including the controllable semiconductor to be bypassed and removed from the electrical path.

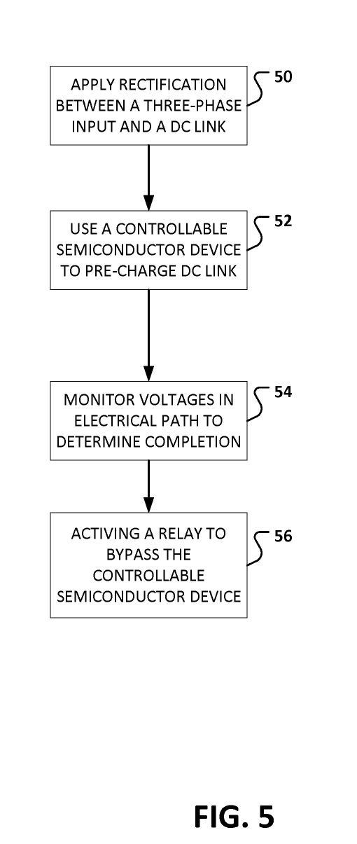

FIG. 5 shows a flowchart of an embodiment of a process to perform pre-charging of the DC link. At 50, the rectification of the three-phase input is applied between the input and the DC link. The controllable semiconductor device is used to pre-charge the DC link at 52, and the voltage(s) is/are monitored to determine completion of the pre-charging at 54. Once the pre-charge has been completed, a relay is activated to bypass the controllable semiconductor device to move the system to normal operations.

Particularly for DC links with nominal voltages up to approximately 1000 V DC, the embodiments of the present disclosure offer cost-effectiveness compared to other solutions. Power electronic components in this voltage range are designed exclusively for switching operation, so selection and dimensioning must be done very carefully. Possible options include metal-oxide-semiconductor field-effect transistors (MOSFETs) or insulated-gate bipolar transistors (IGBTs) with appropriate power capabilities. When considering the necessary cooling, the transient thermal behavior must be particularly considered.

Advantages of the present disclosure include smaller installation space, fast pre-charging with a reduction in inrush currents, utilization of existing infrastructure, such as heat sinks, control units, etc., automated manufacturability where the component is available in surface mounted devices (SMDs), and cost reduction. As mentioned above, the approach in FIG. 4 has a higher component count but is more cost efficient.

Further reduction in pre-charging time can be achieved if the input stage uses constant power for pre-charging, instead of a constant current source. This constant power is particularly facilitated if the system has digitized measurements of the required quantities available that ease such implementation by digital signal processing. In such a system, the constant current source may be controllable, and the measured quantities of current and voltage may be digitally recorded and processed. In some embodiments, the controller may comprise a digital signal processor for processing the digitized measurements. Control with constant power allows for maximum utilization of the device used, which can be operated close to its maximum power dissipation.

To achieve constant power pre-charging, it is necessary to measure the power dissipation of the device. Measurement of power dissipation of the device can be done, for example, by multiplying the pre-charging current by the difference between the DC link voltage and the auxiliary voltage. When the pre-charging is complete, meaning the capacitors are charged to the required level, the relays on the input side are closed, and the power flows through the B6C bridge as in FIG. 4, where the B6C bridge would be out of the path until the relay(s) closes.

Depending on the structure of the PFC, it is advisable to perform synchronization on the input side before switching the relays to prevent high current flow into the PFC filter capacitors during relay switching.

Aspects of the disclosure may operate on a particularly created hardware, on firmware, digital signal processors, or on a specially programmed general-purpose computer including a processor operating according to programmed instructions. The terms controller or processor as used herein are intended to include microprocessors, microcomputers, Application Specific Integrated Circuits (ASICs), and dedicated hardware controllers. One or more aspects of the disclosure may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device. The computer executable instructions may be stored on a non-transitory computer readable medium such as a hard disk, optical disk, removable storage media, solid state memory, Random Access Memory (RAM), etc. As will be appreciated by one of skill in the art, the functionality of the program modules may be combined or distributed as desired in various aspects. In addition, the functionality may be embodied in whole or in part in firmware or hardware equivalents such as integrated circuits, FPGA, and the like. Particular data structures may be used to more effectively implement one or more aspects of the disclosure, and such data structures are contemplated within the scope of computer executable instructions and computer-usable data described herein.

The disclosed aspects may be implemented, in some cases, in hardware, firmware, software, or any combination thereof. The disclosed aspects may also be implemented as instructions carried by or stored on one or more or non-transitory computer-readable media, which may be read and executed by one or more processors. Such instructions may be referred to as a computer program product. Computer-readable media, as discussed herein, means any media that can be accessed by a computing device. By way of example, and not limitation, computer-readable media may comprise computer storage media and communication media.

Computer storage media means any medium that can be used to store computer-readable information. By way of example, and not limitation, computer storage media may include RAM, ROM, Electrically Erasable Programmable Read-Only Memory (EEPROM), flash memory or other memory technology, Compact Disc Read Only Memory (CD-ROM), Digital Video Disc (DVD), or other optical disk storage, magnetic cassettes, magnetic tape, magnetic disk storage or other magnetic storage devices, and any other volatile or nonvolatile, removable or non-removable media implemented in any technology. Computer storage media excludes signals per se and transitory forms of signal transmission.

Communication media means any media that can be used for the communication of computer-readable information. By way of example, and not limitation, communication media may include coaxial cables, fiber-optic cables, air, or any other media suitable for the communication of electrical, optical, Radio Frequency (RF), infrared, acoustic or other types of signals.

### EXAMPLES

Illustrative examples of the disclosed technologies are provided below. An embodiment of the technologies may include one or more, and any combination of, the examples described below.

Example 1 a power factor conversion (PFC) input stage to pre-charge a DC link, comprising: a three-phase power input; a rectifier in a main electrical path between the three-phase power input and the DC link; a controllable semiconductor device configured as a constant current source between the rectifier and the DC link; a controller; and a relay.

Example 2 is the PFC input stage of Example 1, wherein the semiconductor device is connected to the rectifier directly after the rectifier in the main electrical path, and the rectifier comprises a main B6C rectifier.

Example 3 is the PFC input stage of Example 2, comprising one or more measurement points including a measurement point adjacent to the semiconductor device, and the controller is configured to use a measurement from the measurement point to determine completion of a pre-charging process.

Example 4 is the PFC input stages of Example 2, wherein the controller is configured to activate the relay when pre-charging of the DC link is complete to bypass the controllable semiconductor device from the main electrical path.

Example 5 is the PFC input stage of any of Examples 1 through 4, wherein the semiconductor device is connected to the rectifier in an auxiliary rectification path, the auxiliary rectification path comprising an electrical path parallel to the main electrical path.

Example 6 is the PFC input stage of Example 5, further comprising one or more measurement points comprising one or more of a measurement point at a DC link voltage point, and an auxiliary measurement point between the three-phase power input and the semiconductor device, the controller configured to use measurements from the DC link voltage point and the auxiliary measurement point to determine completion of a pre-charging process.

Example 7 is the PFC input stage of Example 6, wherein the controller is configured to activate the relay when a pre-charging voltage is complete to bypass the auxiliary rectification path such that the PFC input stage uses the main electrical path.

Example 8 is a method of pre-charging a DC link in a power supply having a three-phase input, comprising: applying rectification in an electrical path between the three-phase input and the DC link to rectify the three-phase input; using a controllable semiconductor device as a constant current source for pre-charging the DC link after the rectification in the electrical path; monitoring, with a controller, one or more voltages in the electrical path to determine when the pre-charging has completed; and activating a relay to bypass the controllable semiconductor device from the electrical path.

Example 9 is the method of Example 8, wherein applying rectification in an electrical path comprises applying rectification with a main B6C rectifier in a main electrical path.

Example 10 is the method of Example 9, wherein activating the relay results in bypassing the controllable semiconductor device in the main electrical path.

Example 11 is the method of any of Examples 8 through 10, wherein monitoring one or more voltages comprises measuring voltage at one or more measurement points, the measurement points including a measurement point adjacent the semiconductor device, and the controller is configured to use a measurement from the measurement point to determine completion of the pre-charging.

Example 12 is the method of any of Examples 8 through 11, wherein applying rectification comprises applying rectification in an auxiliary rectification path and the controllable semiconductor device resides in the auxiliary rectification path.

Example 13 is the method of Example 12, wherein activating the relay results in bypassing the auxiliary rectification path to use a main electrical path.

Example 14 is a power factor conversion (PFC) input stage to pre-charge a DC link, comprising: a three-phase power input; a rectifier in a main electrical path between the three-phase power input and the DC link; a controllable semiconductor device configured as a constant power source between the rectifier and the DC link; a controller; and a relay.

Example 15 is the PFC input stage of Example 14, comprising one or more measurement points including a measurement point adjacent to the semiconductor device, and the controller is configured to use a measurement from the measurement point to determine completion of a pre-charging process.

Example 16 is the PFC input stage of Example 15, wherein the measurement is a digitized measurement, and the controller comprises a digital signal processor.

Example 17 is the PFC input stage of Example 15, wherein the controller is configured to measure power dissipated by the device.

Example 18 is the PFC input stage of Example 17, wherein the controller is configured to measure power dissipated by the device by multiplying a pre-charging current by a difference between a DC link voltage and an auxiliary voltage.

Example 19 is the PFC input stage of Example 17, wherein the controller comprises analog circuitry.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

Additionally, this written description makes reference to particular features. It is to be understood that the disclosure in this specification includes all possible combinations of those particular features. For example, where a particular feature is disclosed in the context of a particular aspect, that feature can also be used, to the extent possible, in the context of other aspects.

Also, when reference is made in this application to a method having two or more defined steps or operations, the defined steps or operations can be carried out in any order or simultaneously, unless the context excludes those possibilities.

Although specific aspects of the disclosure have been illustrated and described for purposes of illustration, it will be understood that various modifications may be made without departing from the spirit and scope of the disclosure. Accordingly, the invention should not be limited except as by the appended claims.

1. A power factor conversion (PFC) input stage to pre-charge a DC link, comprising:
a three-phase power input;
a rectifier in a main electrical path between the three-phase power input and the DC link;
a controllable semiconductor device configured as a constant current source between the rectifier and the DC link;
a controller; and
1a relay.

2. The PFC input stage as claimed in claim 1, wherein the semiconductor device is connected to the rectifier directly after the rectifier in the main electrical path, and the rectifier comprises a main B6C rectifier.

3. The PFC input stage as claimed in claim 2, comprising one or more measurement points including a measurement point adjacent to the semiconductor device, and the controller is configured to use a measurement from the measurement point to determine completion of a pre-charging process.

4. The PFC input stages as claimed in claim 2, wherein the controller is configured to activate the relay when pre-charging of the DC link is complete to bypass the controllable semiconductor device from the main electrical path.

5. The PFC input stage as claimed in claim 1, wherein the semiconductor device is connected to the rectifier in an auxiliary rectification path, the auxiliary rectification path comprising an electrical path parallel to the main electrical path.

6. The PFC input stage as claimed in claim 5, further comprising one or more measurement points comprising one or more of a measurement point at a DC link voltage point, and an auxiliary measurement point between the three-phase power input and the semiconductor device, the controller configured to use measurements from the DC link voltage point and the auxiliary measurement point to determine completion of a pre-charging process.

7. The PFC input stage as claimed in claim 6, wherein the controller is configured to activate the relay when a pre-charging voltage is complete to bypass the auxiliary rectification path such that the PFC input stage uses the main electrical path.

8. A method of pre-charging a DC link in a power supply having a three-phase input, comprising:
applying rectification in an electrical path between the three-phase input and the DC link to rectify the three-phase input;
using a controllable semiconductor device as a constant current source for pre-charging the DC link after the rectification in the electrical path;
monitoring, with a controller, one or more voltages in the electrical path to determine when the pre-charging has completed; and
activating a relay to bypass the controllable semiconductor device from the electrical path.

9. The method as claimed in claim 8, wherein applying rectification in an electrical path comprises applying rectification with a main B6C rectifier in a main electrical path.

10. The method as claimed in claim 9, wherein activating the relay results in bypassing the controllable semiconductor device in the main electrical path.

11. The method as claimed in claim 8, wherein monitoring one or more voltages comprises measuring voltage at one or more measurement points, the measurement points including a measurement point adjacent the semiconductor device, and the controller is configured to use a measurement from the measurement point to determine completion of the pre-charging.

12. The method as claimed in claim 8, wherein applying rectification comprises applying rectification in an auxiliary rectification path and the controllable semiconductor device resides in the auxiliary rectification path.

13. The method as claimed in claim 12, wherein activating the relay results in bypassing the auxiliary rectification path to use a main electrical path.

14. A power factor conversion (PFC) input stage to pre-charge a DC link, comprising:
a three-phase power input;
a rectifier in a main electrical path between the three-phase power input and the DC link;
a controllable semiconductor device configured as a constant power source between the rectifier and the DC link;
a controller; and
14a relay.

15. The PFC input stage as claimed in claim 14, comprising one or more measurement points including a measurement point adjacent to the semiconductor device, and the controller is configured to use a measurement from the measurement point to determine completion of a pre-charging process.

16. The PFC input stage as claimed in claim 15, wherein the measurement is a digitized measurement, and the controller comprises a digital signal processor.

17. The PFC input stage as claimed in claim 15, wherein the controller is configured to measure power dissipated by the semiconductor device.

18. The PFC input stage as claimed in claim 17, wherein the controller is configured to measure power dissipated by the device by multiplying a pre-charging current by a difference between a DC link voltage and an auxiliary voltage.

19. The PFC input stage as claimed in claim 17, wherein the controller comprises analog circuitry.
